(19) United States
(12) Patent Application Publication
(10) Pub. No.: US 2004/0056371 A1
(43) Pub. Date: Mar. 25, 2004

(54) Method of manufacturing ophthalmic lenses made from hydrophobic acrylic polymers

(75) Inventors: Xiugao Liao, Irvine, CA (US); Christopher D. Wilcox, Mission Viejo, CA (US)

Correspondence Address: FROST BROWN TODD, LLC, 2200 PNC CENTER, 201 E. FIFTH STREET, CINCINNATI, OH, 45202, US

(73) Assignee: Medennium, Inc.

(21) Appl. No.: 10/647,875

(22) Filed: Aug. 25, 2003

Related U.S. Application Data
(60) Provisional application No. 60/413,502, filed on Sep. 25, 2002.

(51) Int. Cl. B29D 11/00

(52) U.S. Cl. 264/2.5; 264/2.6

(57) ABSTRACT

A method of forming an ophthalmic lens, such as an intraocular lens, from a hydrophobic acrylic polymer is disclosed. In this method, a pre-polymer gel is formed form the hydrophobic acrylic polymer, at least the optical portion of the lens is formed from the gel using a fused silica mold, and the lens is solvent extracted such that it remains transparent and substantially without glistenings in an aqueous medium.

### CROSS REFERENCE TO RELATED APPLICATION

This application is based on and claims priority from U.S. Provisional Application No. 60/413,502, Liao and Wilcox, filed Sep. 25, 2002, incorporated herein by reference.

### TECHNICAL FIELD

The present invention relates broadly to the method of manufacturing ophthalmic implants made from hydrophobic elastomeric acrylic polymers. Specifically, it relates to a process for pre-polymer gel preparation and the direct molding of all or part of an ocular implant made from hydrophobic elastomeric acrylic polymers. The present invention also relates to an efficient extraction process for ocular lenses made from hydrophobic elastomeric acrylic polymers. The extracted lenses remain transparent and substantially glistening-free in an aqueous medium at 37° C. The ophthalmic lenses made from hydrophobic elastomeric acrylic polymers include but are not limited to cornea implants for artificial keratoplasty, cornea inlay lenses or cornea onlay lenses for correction of refractive errors, intraocular lenses for cataract surgery, phakic intraocular lenses in the anterior chamber of the eye, and phakic intraocular lenses in the posterior chamber of the eye.

### BACKGROUND OF THE INVENTION

The term “ocular implant” is used interchangeably herein with “ophthalmic implant.” Ophthalmic implants are defined in a broad sense as all devices surgically implanted in the eye. Examples of ophthalmic implants include, but not are limited to, intraocular lenses, cornea lenses, glaucoma shunts, and drug delivery devices inserted inside the eye.

The terms “ocular lens” and “ophthalmic lens” are also used interchangeably herein. Ophthalmic lenses are the optical devices used for correction of refractive errors, such as nearsightedness (myopia), farsightedness (hyperopia), astigmatism, and presbyopia. Ophthalmic lenses can be divided into two classes based on whether the natural crystalline lens is absent (aphakic) or present (phakic): aphakic lenses and phakic lenses. Aphakic lenses are artificial lenses that replace a surgically removed natural crystalline lens. Phakic lenses are artificial lenses that work together with the natural crystalline lens to correct refractive errors. Examples of aphakic lenses are intraocular lenses implanted after cataract surgery. Examples of phakic lenses are cornea lenses, lenses positioned in the anterior chamber of the eye and in the posterior chamber of the eye.

“Hydrophobic” refers to a material lacking affinity for water, while “hydrophilic” refers to a material with affinity for water. Chemically speaking, a substance containing a hydroxyl group (—OH) generally is not a hydrophobic material. Rather, it is a hydrophilic material. A typical hydrophilic acrylic polymer is poly(hydroxyethyl-methacrylate), or Poly(HEMA). Any acrylic polymers containing poly(HEMA) are generally considered hydrophilic. As a matter of fact, poly(HEMA) absorbs water with a water percentage as high as 40% of its overall weight. For its simplicity, hydrophobic acrylic polymers used in the present invention generally do not absorb substantial amounts of water, with a water percentage less than 1% of their overall weight.

Generally speaking, ocular implants can be fabricated into a desirable shape and dimension either by machining, such as using a computer-assisted lathing machine, or direct molding. In the latter method, a desired cavity is created in the mold, the appropriate material is transferred into the cavity and then permanently shaped in the cavity. The ocular implant formed takes the shape of the cavity with desirable dimensions and surface finish. In the case of intraocular lenses (IOLs), a highly smooth surface finish and perfectly curved surface are required so that the lens can provide sufficient optical power and resolution. Therefore, the cavity of the mold needs to be precisely made and its surface needs to be appropriately polished.

The molding method is particularly suitable for the fabrication of foldable IOLs. This is because a foldable IOL is so soft that it cannot be machined without cooling to a very low temperature, at which point it becomes rigid. Foldable IOLs are increasingly used by ophthalmologists to replace the old generation of hard poly(methylmethacrylate) (PMMA) IOLs. The hard PMMA IOLs, which are usually cut by a precision lathing machine, need to be implanted through a 6 mm incision while the foldable IOL only needs an incision size of about 3.5 mm because the foldable IOL can be folded in half and then inserted through the incision. This reduced incision size utilized with the foldable IOL not only reduces the healing time but also reduces incision-induced astigmatism.

A mold and a molding process suitable for the production of intraocular lenses require a very high precision and accuracy with an optical surface finish; the process of the present invention meets those highly demanding conditions. The present invention is also suitable for the fabrication of non-lens ophthalmic implants, such as drug delivery devices, sclera expansion rings, glaucoma implants, and capsular rings. In these cases, the requirement for a mold and molding conditions can be less demanding because the non-lens implants do not require optical properties. For this reason, a mold and its molding process for the manufacturing of an intraocular lens is used for the purpose of illustrating the teachings of the present invention, but not to limit the scope of the present invention.

One requirement for the direct molding of an IOL made from hydrophobic elastomeric acrylic polymers is that the precursor polymer composition needs to have a desirable viscosity. Usually, this is done by preparation of a “pre-polymer” or pre-gel polymer. A pre-polymer is formed by partially polymerizing the mixture solution of the IOL-forming composition to a desirable range of viscosity. For example, U.S. Pat. No. 6,313,187, LeBoeuf et al., issued Nov. 6, 2001, and references cited therein describe a pre-polymer process for producing a UV absorber-containing IOL material. The process is basically a partial polymerization of the mixture solution of the all the necessary components, such as monomers, UV absorber substances, crosslinkers and initiators. The partial polymerization can be stopped when the viscosity increases to a desirable level. Such a prepolymer can be filtered to remove small impurity particles. The filtered prepolymer is a viscous solution ready for use in casting IOLs in a mold.

However, when a crosslinker is mixed in the material, an insoluble material may be formed in the pre-polymer step, making the filtration process very difficult or simply impossible. Furthermore, the polymer produced after subsequent curing steps become non-uniform. To overcome this deficiency, U.S. Pat. No. 6,313,187, Gupta, issued May 30, 1989, discloses a two-step process. In the first step, monomers containing no crosslinkers are polymerized. In the second step, the material is crosslinked by exposure to heat. Another way to overcome the deficiency is disclosed in U.S. Pat. No. 4,834,750. The combination of monomers without the crosslinker is partially crosslinked to form a syrup. The syrup is then mixed with crosslinker and additional initiators for further curing and the formation of IOLs. However, the inventor was silent about whether and how the uncrosslinked syrup will impact the final lens performance due to the presence of uncrosslinked polymers in the final product. The uncrosslinked polymers in the IOL may slowly leach out, an undesirable situation that manufacturers seek to avoid.

Another requirement for the direct molding of an IOL made from hydrophobic elastomeric acrylic polymers is that IOLs formed inside the mold need to be easily removable from the mold without sticking. This is particularly a challenge for acrylic materials since such materials generally have a great adherence force to many surfaces. Acrylic materials are widely used as the key component in many adhesives. U.S. Pat. No. 5,290,892, Namdaran et al., issued Mar. 1, 1994, discloses that the lens with the optic body can be molded between two polypropylene mold halves. However, polypropylene generally has a melting temperature in the range of 135° C. (syndiotactic) to 165° C. (isotactic) depending on its stereochemistry. Polypropylene softens at a temperature lower than its melting temperature. Therefore, when polypropylene is used as the mold material, the curing temperature has to be maintained in a low temperature condition. In addition, any softening and expansion of the polypropylene mold material during curing will cause the lens inside the mold to deviate from its original cavity's shape and dimensions. As a result, lenses made from the polypropylene mold may change into a deformed and unpredictable shape and dimension, a very undesirable property for an optical device.

In order to make a mold from a more robust material which does not soften at a high temperature, Blake in his U.S. Pat. No. 5,104,590, issued Apr. 14, 1992, and U.S. Pat. No. 5,185,107, issued Feb. 9, 1993, disclosed a coining process for forming an optical mold by pressing a hard mandrel with highly polished surface into a blank which is softer than the mandrel material at high temperature. Molds processed in such a way need additional surface polishing in order to achieve a desirable lens surface finish. In addition, the dimension of the metal mold cavity, made by the coining process, may be affected by the temperature cycles inherent in the molding process. Furthermore, molds made from stainless steel and metal alloys were found to be not suitable for a hydrophobic acrylic IOL manufacturing process because IOLs tend to stick onto the mold surface. Removing IOLs from the metal mold frequently resulted in lens surface damage.

A further requirement for a hydrophobic acrylic IOL is that the lens should be substantially glistening-free once implanted in the eye. This glistening formation can be observed in a simulated condition in an aqueous medium at 37° C. It has been well known to surgeons that hydrophobic acrylic IOLs have “glistenings” (i.e., areas where the lenses appear to glare or reflect some light) once implanted in the eye for patients after cataract surgery. Detailed description of glistenings observed in hydrophobic acrylic IOLs can be found in the following literature references: (1) Koichi et al, “Glistening formation in an acrylic lens initiated by spinodal decomposition of the polymer network by temperature change” J. Cataract Refractive Surg. Vol. 27, 1493-1498 (2001) and references therein; (2) Gunenc et al, “Effects on visual function of glistenings and folding marks in AcrySof ontraocular lenses” J. Cataract Refractive Surg. Vol. 27, 1611-1614 (2001), and references therein. It was found that the manufacturing process has a significant influence in lens glistening levels. In other words, an optimized process for manufacturing IOLs can eliminate glistenings while a compromised process produces an IOL with significant glistenings.

In the process of the present invention, preparation of pre-gel is preferred for the fabrication of IOLs made from hydrophobic acrylic polymeric materials in a molding process. The pre-gel polymer is preferably passed through a filter with an appropriate pore size: this would require an uncrosslinked pre-gel polymer. It will also require that the uncrosslinked pre-gel polymer not be leached out from the finished IOLs. In addition, the direct molding of IOLs from the pre-gel polymer requires that IOLs formed inside the mold be easily removed from the mold. Furthermore, finished IOLs must have three dimensional crosslinked networks by an optimized curing process. Finally, by utilizing an efficient and optimized extraction process, finished IOLs must be highly pure without leachable impurities in order to eliminate glistenings. The present invention satisfies all of these requirements.

### SUMMARY OF THE INVENTION

Generally speaking, the present invention comprises methods for successfully preparing ophthalmic implants made from hydrophobic acrylic polymers. The method comprises a pre-polymer gelation process, mold surface modification and assembly, curing, and an efficient extraction process which minimizes leachable impurities and lens glistenings.

In one exemplary embodiment of the present invention, the ophthalmic implant is an intraocular lens made from a hydrophobic elastomeric acrylic polymer comprising monomers including, but not limited to, phenoxyethyl acrylate, poly(ethylene glycol)phenylethylacrylate, 2-phenylethylacrylate, 3-phenylethylacrylate, 4-phenylethylacrylate, and alkylacrylate derivatives. These polymers are preferably to be crosslinked with a suitable crosslinking agent.

In one exemplary embodiment of the pre-polymer gelation, the process comprises the steps of (1) mixing monomers with initiators; (2) slowly warming the mixture while stirring until the solution become one single piece gel; (3) cooling the gel down to a temperature of 0° C. or lower; (4) adding a crosslinking agent to the gel; (5) stirring the mixture vigorously with a mechanical stirrer until the gel becomes uniformly dispersed in the mixture; (6) preferably passing the mixture through a filter with a pore size less than about one micrometer.

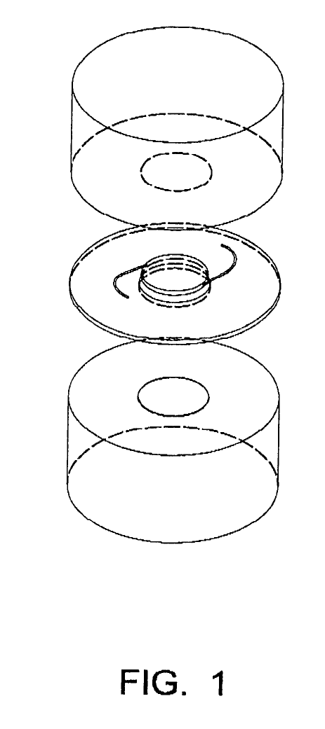

In one exemplary embodiment of the mold preparation, a pair of fused silica molds is assembled as shown in FIG. 1. The fused silica molds may be surface treated with trimethylchlorosilane in ethyl acetate solution. The treated surface greatly reduces the adherence of IOLs onto the mold surface. Therefore, cured lenses can be easily removed from the mold.

In one exemplary embodiment of the IOL extraction for removing all impurities after the IOL is molded, alcohol solvents are used in a standard soxhlet apparatus for at least 24 hours. It is found that alcohols are generally effective solvents for extraction. An efficient extraction step is a critical element of the whole manufacturing process for producing IOLs without leachable impurities and without glistenings in an aqueous medium. In addition, light transmission measurement in a simulated aqueous medium can be utilized in determination of lens clarity and the severity of glistenings. The higher the light transmission, the better the optical performance of the lens. On the other hand, when a hydrocarbon solvent, such as hexane is used, it shows insufficient removal of impurities from the lens both in terms of weight loss percentage and light transmission test in an aqueous medium (see Example 5 and Table 2 for details).

The combination of foregoing exemplary embodiments, their detailed descriptions, and Examples provide whose who are skilled in the art with sufficient information for the successful preparation of ophthalmic implants made from hydrophobic acrylic polymers according to the present invention.

### DETAILED DESCRIPTION OF THE INVENTION

FIG. 1 is an example of a mold assembly suitable for direct molding of a three-piece IOL. The paired fused silica molds may be surface treated with trimethylchlorosilane for smooth lens release from the mold cavity.

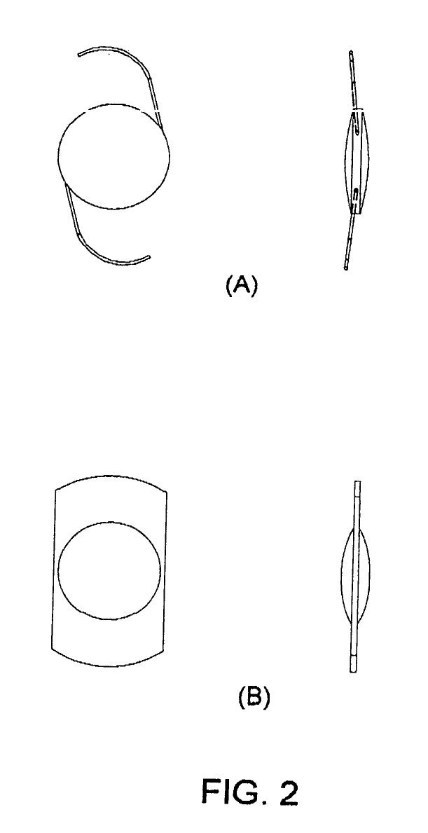

FIG. 2(A) is a conventional three-piece IOL design commonly used for caratact surgery. FIG. 2(B) is a plate lens design also commonly used for cataract surgery.

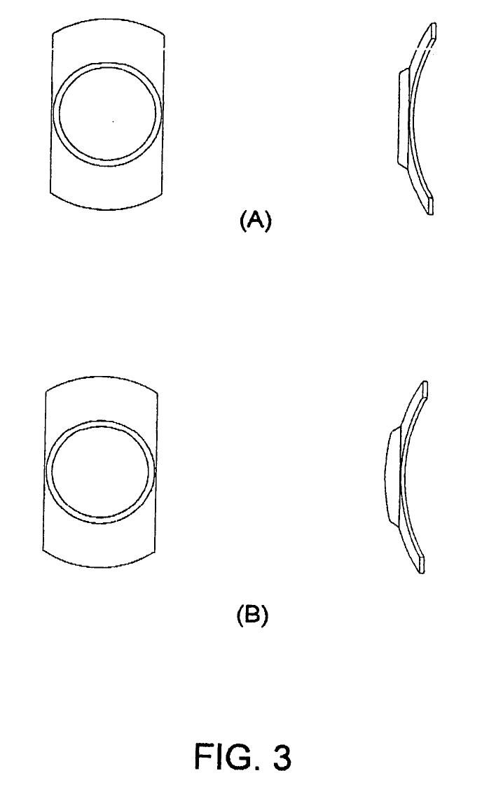

FIG. 3(A) is a negative phakic refractive lens for the correction of myopia suitable for positioning in the posterior chamber of the eye with the human crystalline lens intact. FIG. 3(B) is a positive phakic refractive lens for the correction of hyperopia suitable for positioning in the posterior chamber of the eye with the human crystalline lens intact.

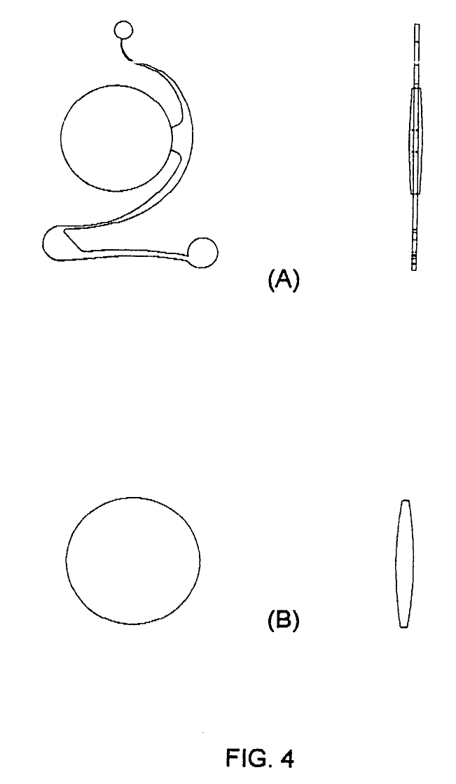

FIG. 4(A) is a design of an IOL suitable for positioning in the anterior chamber of the eye with or without the human crystalline lens intact. FIG. 4(B) is full size IOL design with the lens diameter approximately equal to that of a human crystalline lens (about 9.5 mm).

The present invention provides a number of detailed steps for preparation of ophthalmic lenses made from hydrophobic acrylic polymers. These steps are unique and require special conditions under which a desirable ophthalmic lens can be successfully fabricated. These special conditions are very important and permit the manufacture of high quality hydrophobic acrylic lenses. Specifically, these steps in the present invention include (1) pre-polymer gelation, (2) mold surface modification and mold assembly preparation, (3) curing in the fused silica mold and extraction of IOLs in an appropriate organic solvent as well as subsequent removal of organic solvent by a drying process.

Generally speaking, the preparation of ophthalmic lenses from a liquid mixture of monomers with low viscosity (less than 100 cps, for example) is not preferred for manufacturing purposes because it is difficult to transfer a low viscosity liquid monomer onto a mold without leaking and because of large shrinkage due to polymerization inside the mold. To reduce shrinkage during molding and to have a manufacturable process, preparation of a viscous pre-polymer gel through partial polymerization of monomers is carried out. The viscous gel prepared this way is then preferably passed through a filter with a pore size of about one micrometer to remove small particles before molding a lens.

However, if a crosslinker is used in the gelation process, the resulting gel is crosslinked and its size may become too big to pass through the filter. On the other hand, if a crosslinker is not used, the linear polymer formed during the pre-gel process can be easily run through the filter but particulates may also be removed during extraction, a process designated for removing all possible leachable impurities in the finished lens. The loss of pre-polymer in the extraction step may result in a large percentage of weight loss in the lens, which will negatively impact the optical quality of the lens due to the shrinkage caused by the large weight loss. Therefore, there must be an appropriate balance of weight loss and optical quality. In order to maximize the lens optical quality without loss of unnecessary optical quality, the present invention utilizes a slow gelation process of the monomer mixture without the crosslinker. The pre-polymer gel prepared this way contains linear polymers having a molecular weight (MW) of at least about one million. A crosslinker is then added to the gel and rigorously mixed by a mechanical stirrer. The resulting mixture can be successfully filtered and used for molding intraocular lenses.

The high MW of uncrosslinked pre-gel polymer has two benefits. First, it reduces the total weight percentage of uncrosslinked pre-gel polymers in the final mixture of a fixed viscosity. This way, the curing process during molding will result in a more complete three dimensional network. Second, linear pre-polymers with high MW from the gelation process form a semi-interpenetrating network with the crosslinked polymer chains in the molded lenses. Consequently, they cannot be removed by an extraction process. This way, the present invention effectively avoids the use of a crosslinker during pre-polymer gelation without sacrificing lens optical properties due to a large percentage of weight loss or shrinkage.

Exemplary embodiments for the hydrophobic acrylic polymers used in the present invention include homopolymers and copolymers as well as their crosslinked counterparts with appropriate crosslinkers. Monomers suitable for the preparation of hydrophobic acrylic polymers cover a wide range of structures including, but not limited to: phenoxyethylacrylate, 2-phenylethylacrylate, methylacrylate, ethylacrylate, hexylmethacrylate, laurylmethacrylate, stearylacrylate, methylmethacrylate, phenoxyethylmethacrylate, 2-phenylethylmethacrylate, laurylmethacrylate, stearylmethacrylate, alkylacrylate derivatives and alkylmethacrylate derivatives.

Crosslinkers for the homopolymer of the present invention are selected from a wide group of diacrylates or dimethacrylates or a mixture thereof. However, they are preferably selected from the those with a rigid structure group. The rigid group includes, but is not limited, to the structure of alkylaryl, biphenyl and naphthalene groups and other similar structures. Examples of crosslinkers containing a rigid group are: diacrylates and dimethacrylates of bisphenol A ethoxylate (1 EO/phenol), bisphenol A ethoxylate (2 EO/phenol), bisphenol A propoxylate (2 PO/phenol), bisphenol A, 2,2′-diallylbisphenol A, bis(4-(2-acryloylethoxy)phenyl)methane, bis(4-(2-methacryloylethoxy)phenyl)methane, bis(naphthol) A ethoxylate (X EO/naphthol), bis(2-acryloylalkylphenyl)propane, bis(2-methacryloylalkylphenyl)propane, 3,3′-(ethylenedioxy)diphenyl A ethoxylate (X EO/phenol), and naphthdiol A ethoxylate(2X EO/naphthalene), wherein X=1-5. For example, a mixture of 95% phenoxyethylacrylate and 5% of bisphenol A dimethacrylate with optional WV absorbers can be heated to about 45° C. in the presence of free radical initiator, such as azobisisobutyronitrile (AIBN). After the pre-polymer gelation process, IOLs can be made from this viscous gel and easily released from the fused silica mold.

Crosslinkers suitable for the copolymer in the present invention can be, in general, any difunctionally polymerizable molecule. Examples include, but are not limited to, ethyleneglycol diacrylate, ethyleneglycol dimethacrylate, 1,3-propanediol diacrylate, 1,3-propanediol dimethacrylate, 1,4-butanediol diacrylate, 1,4-butanediol dimethacrylate, 1,6-hexanediol diacrylate, 1,6-hexanediol dimethacrylate, allyl acrylate, allyl methacrylate, etc.

The hydrophobic acrylic polymer suitable for ophthalmic lenses in the present invention optionally includes a UV absorbing agent to block UV rays from entering the eye. Examples of suitable UV absorber agents include substances containing a benzophenol chromophor or benzotriazol chromophor. Specifically, the following chemicals can be used as a UV absorber: 2-(4-benzoyl-3-hydroxyphenoxy)ethyl acrylate, 2-hydroxy-4-allyloxybenzophenone, 2-(2′-hydroxy-5-acryloxyethylphenyl)-2H-benzotriazole, and 2-(2′-hydroxy-5-methacryloxyethylphenyl)-2H-benzotriazole.

It is known that hydrophobic acrylic polymers are sticky. As matter of fact, acrylic polymers are used as a component in many adhesives. Normally, a metal mold is used for casting an ophthalmic lens, such as in the silicone lens manufacturing process. For example, molds made from a metal alloy or stainless steel have been used successfully in manufacturing of silicone intraocular lenses. However, in the case of a hydrophobic acrylic polymer, the lens simply sticks in the mold due to the excellent adhesion of the hydrophobic polymer to the alloy metal surface. It is very difficult, if not impossible, to remove the lens from the alloy metal mold without damaging the lens.

When a mold made from fused silica is used for the casting of an intraocular lens from the hydrophobic acrylic polymeric gel, the lens is much easier to release from the fused silica mold than a metal mold. The IOL does not stick to the fused silica surface because the fused silica surface is hydrophilic due to the fact it contains free hydroxyl groups. The lens releasability may be further improved by the surface modification of the fused silica mold with trimethylchlorosilane. After the surface modification process, hydroxyl groups on the mold surface are chemically bonded with trimethylsilyl. In a typical case, the trimethylsilyl-capped surface of a fused silica mold lasts a few months depending the level of usage. Once the surface wears out, it can be re-treated with the same procedure. This re-treatment can be repeated as long as the optical surface of the fused silica mold remains smooth (See Example 4 for detailed experimental conditions).

After IOLs are removed from the fused silica mold, it is necessary to post-cure the IOL at an elevated temperature to complete the polymerization and crosslinking. However, even with a best curing process, there are always existing un-reacted monomers, non-active monomers, low molecular weight oligomers and other impurities in the cured IOL. These impurities must be removed as completely as possible to ensure lens clarity and biocompatibility, i.e., no leachable impurities once the lens is implanted in the eye.

Various extraction methods were tested for their feasibility. Lenses placed in isopropanol (EPA) in a flask were stirred for 3 days at 50° C. in a shaker with a fresh solvent at least once in every 24 hours. Alternatively, a standard soxhlet extraction apparatus was also used for IOL extraction with various organic solvents. While alcoholic solvents generally performed with much better efficiency than alkanes, it appears that ethanol was a particularly effective solvent among all solvents tested. In addition, extraction time also played a significant role in minimizing the lens haziness or glistenings. Generally extraction takes place for at least about 24 hours; preferably the extraction time is in the range of from about 48 to about 72 hours.

Furthermore, it was found that drying conditions also play an important role in eliminating glistenings, It was found that a slow drying process is preferred with a long drying time, such as about 48 hours or more, and that the drying temperature needs to be lower than the boiling temperature of the solvent used for extraction. Fast drying processes tend to result in the frequent formation of glistenings in the finished lens.

### EXAMPLE 1

Homopolymer Pre-Gel Preparation

In a 2 liter round bottom flask, 550 grams of phenoxyethyl acrylate (as received from Sartomer), 8 grams of 2-(4-benzoyl-3-hydroxyphenoxy)ethyl acrylate as a UV absorber, and 0.71 grams of azobisisobutyronitrile (AIBN) are mixed at room temperature until all solid UV absorber is dissolved. After degassing with nitrogen, the mixture solution is then heated to 45° C. while stirring with a magnetic stirring bar and under the protection of nitrogen atmosphere. The solution becomes gradually viscous. When the magnetic stirring bar stops stirring, the free radical polymerization is suspended by rapid cooling with liquid nitrogen. After the frozen reaction mixture is allowed to warm up to the room temperature, 26 grams of crosslinker, bisphenol A ethoxylate (2 EO/phenol) dimethacrylate (purchased from Sartomer, used as received) is added to the highly viscous pre-polymer gel. The resulting mixture is stirred vigorously with a mechanical stirrer for about 2 hours until a homogenous viscous solution is obtained. The final solution is passed through a filter with a pore size less than one micrometer, and placed into pre-cleaned syringes. The viscosity of the filtered gel is in the range of 400 to 1,800 cps. Molecular weights of the pre-polymer fraction are Mw/Mn=10.2/3.8 million as measured by GPC. Table 1 summarizes the molecular weight, viscosity of 10 batches of pre-polymer solution.

TABLE 1
Molecular Weight (MW) of Pre-polymer Gels by GPC

| | Weight Average | Number Average | | Viscosity |
|---|---|---|---|---|
| ID | MW (in millions) | MW (in millions) | Poly-dispersity | (cps) |
| 1 | 13.5 | 5.9 | 2.3 | 1570 |
| 2 | 12.8 | 4.5 | 2.8 | 450 |
| 3 | 14.7 | 8.4 | 1.8 | 1700 |
| 4 | 11.5 | 3.9 | 2.9 | 1750 |
| 5 | 15.4 | 9.6 | 1.6 | 1500 |
| 6 | 13.2 | 7.6 | 1.7 | 800 |
| 7 | 14.1 | 6.8 | 2.1 | 1300 |
| 8 | 10.3 | 4.6 | 2.2 | 850 |
| 9 | 10.2 | 3.8 | 2.7 | 500 |
| 10 | 11.0 | 4.7 | 2.3 | 550 |

### EXAMPLE 2

Copolymer Pre-Gel Preparation and Lens Molding

To a round-bottomed flask, equipped with a magnetic stirring bar, is added a mixture of 4.75 grams of stearyl methacrylate, 0.25 gram of methyl methacrylate, 5 microliters of ethylene glycol dimethacrylate, and 0.01 grams of benzoyl peroxide. The flask is purged with nitrogen gas for about 2 minutes and subsequently maintained under positive nitrogen atmosphere. The reaction mixture is then heated to about 110° C. in a silicone oil bath while stirring. After approximately 5 minutes, evolving of gas is observed indicating decomposition of the benzoyl peroxide initiator to form benzoyloxy radicals initiating the polymerization reaction. After approximately 5 minutes from when the initial gas evolution is first observed, the reaction mixture becomes obviously viscous, indicating the polymerization and crosslinking reaction has occurred. Before the reaction mixture becomes too viscous to be poured out from the flask, a small amount of the mixture is taken out with a spatula and is transferred into a surface-treated fused silica mold. The mold is then closed and is placed into a preheated oven at 110° C. for 16 hours. After the mold is taken out from the oven and cools down to room temperature, the mold is placed in a refrigerator for about 2 hours. The mold is then opened. A white or translucent solid IOL is carefully removed from the mold. As the temperature increases to 35° C., the solid lens becomes transparent and soft gel-like.

### EXAMPLE 3

Pre-Polymer Gel Formation with an Alternative Crosslinker

A pre-polymer gel is also prepared by the same process and chemicals as in Example 1 except that 26 grams of bisphenol A ethoxylate (2 EO/phenol) dimethacrylate is replaced with 4.4 gram of ethylene glycol dimethacrylate as the crosslinker.

### EXAMPLE 4

Mold Surface Modification and Mold Assembly

The fused silica mold is heated to about 400° C. in a furnace for approximately 16 hours. After the mold cools down to ambient temperature, it is then soaked in 4% chlorotrimethylsilane solution in ethyl acetate for about 16 hours. The mold is then rinsed with isopropyl alcohol and dried in air. After the surface modification, two pieces of fused silica mold are assembled into a mold set as shown in FIG. 1.

### EXAMPLE 5

IOL Molding, Extraction, and Drying

IOLs are molded in a surface-treated fused silica mold by transferring the pre-polymer gel, obtained either in Example 1 or Example 3, into the mold and curing at 110° C. for 16 hours, followed by post-curing at 140° C. for 4 hours. IOLs prepared this way usually contain impurities, such as un-reacted monomers, crosslinkers etc., which may be leached out into the aqueous humor once implanted in the eye. Therefore, it is imperative to remove these impurities.

In a typical extraction experiment, about 20 IOLs are placed in the standard soxhlet extraction apparatus (purchased from VWR) in a selected organic solvent. In a typical extraction experiment, it is necessary to let soxhlet extraction continue for at least 24 hours, preferably for 48 to 72 hours. The subsequent drying process for the extracted IOLs is conducted by placing the solvent-wet IOL in an oven at a predetermined temperature for at least 24 hours, preferably 48-72 hours. The temperature for the drying process is preferably set at a level below the boiling temperature of the selected extraction solvent. Table 2 summarizes the extraction of IOLs made from the homopolymer pre-gel of Example 1 with various solvents under different conditions. For purposed of comparison, 24 hours of extraction time are used in Table 2.

TABLE 2
Soxhlet Extraction of IOLs with Various Solvents

| | | Dry Time | | Light |
|---|---|---|---|---|
| | Extraction | (hours@ | Weight Loss | Transmission |
| Solvent | Time (hours) | 67° C.) | % | (%) |
| Ethanol | 24 | 24 | 6.8 | 95 |
| Methanol | 24 | 24 his at 45° C. | 6.6 | 88 |
| | | 24 his at 67° C. | | |
| IPA | 24 | 48 | 6.7 | 83 |
| Hexane | 24 | 24 | 5.8 | 75 |

The light transmission is measured in an aqueous medium at 37° C. with a laser beam (light source: HeNe laser with a wavelength 632.8 nm) passing through a home-made wet cell containing the IOL after the IOL had been previously soaked in the aqueous medium for at least 3 days at 37° C. A light transmission percent of 80% (i.e., 20% of the incident light does not pass through the testing sample) or higher in an aqueous medium is considered to pass the standard. Alcohols are generally more efficient solvents than hexane for the IOL extraction. Among all solvents tested, ethanol demonstrated the best extraction efficiency under similar experimental conditions. IOLs extracted with ethanol have a light transmission percentage of approximately 95%.

Lastly, the glistening test is conducted with Nikon's zoom-photo slit lamp equipped with a homemade wet cell, in which IOLs are immersed at a constant temperature of 37° C. In this test, finished IOLs are first soaked in an aqueous medium at 37° C. for at least 3 days and then the soaked IOLs are transferred to the wet cell at 37° C. for visual observation for glistenings by a trained operator. By following this procedure, IOLs extracted with ethanol in a standard soxhlet for 3 days and subsequently dried in an oven at 67° C. for 3 days are shown to be substantially free of glistenings.

What is claimed is:

1. A method of forming an ophthalmic lens from a hydrophobic acrylic polymer composition comprising the steps of:
(a) forming a pre-polymer gel from a hydrophobic acrylic polymer;
(b) forming at least the optical portion of said ophthalmic lens from said pre-polymer gel in a fused silica mold; and
(c) extracting said ophthalmic lens or its optical portion formed in step (b) such that the extracted lens remains transparent in an aqueous medium.

2. The method of claim 1 wherein said ophthalmic lens is an intraocular lens.

3. The method of claim 1 wherein said ophthalmic lens is a phakic refractive lens.

4. The method of claim 1 wherein said ophthalmic lens is a cornea lens.

5. The method of claim 1 wherein said hydrophobic acrylic polymer is a crosslinked homopolymer.

6. The method of claim 5 wherein said homopolymer comprises a monomer selected from phenoxyethylacrylate, poly(ethyleneglycol)phenylethylacrylate, 2-phenylethylacrylate.

7. The method of claim 5 wherein said homopolymer is crosslinked with at least one crosslinker.

8. The method of claim 7 wherein said crosslinker contains a rigid structure group.

9. The method of claim 8 wherein said crosslinker is selected from diacrylates and dimethacrylates of bisphenol A ethoxylate (1 EO/phenol), bisphenol A ethoxylate (2 EO/phenol), bisphenol A propoxylate (2 PO/phenol), bisphenol A, 2,2′-diallylbisphenol A, bis(4-(2-acryloylethoxy)phenyl)methane, bis(4-2-methacryloylethoxy)phenyl)methane, bis(naphthol) A ethoxylate (X EO/naphthol), bis(2-acryloylalkylphenyl)propane, bis(2-methacryloylalkylphenyl)propane, and 3,3′-(ethylenedioxy)diphenyl A ethoxylate(X EO/phenol), and mixtures thereof, wherein X=1 to 5.

10. The method of claim 5 wherein said homopolymer contains a WV absorber.

11. The method of claim 10 wherein said UV absorber is selected from 2-(4-benzoyl-3-hydroxyphenoxy)ethyl acrylate, 2-hydroxy-4-allyloxybenzophenone, 2-(2′-hydroxy-5-acryloxyethylphenyl)-2H-benzotriazole, and 2-(2′-hydroxy-5-methacryloxyethylphenyl)-2H-benzotriazole, and mixtures thereof.

12. The method of claim 1 wherein said hydrophobic acrylic polymer is a crosslinked copolymer.

13. The method of claim 12 wherein said copolymer comprises at least one monomer selected from phenoxyethylacrylate, poly(ethyleneglycol)phenylethylacrylate, 2-phenylethylacrylate, phenoxyethylmethacrylate, poly(ethyleneglycol)phenylethylmethacrylate, 2-phenylethylmethacrylate, methylacrylate, methyl methacrylate, lauryl acrylate, lauryl methacrylate, stearyl acrylate, stearyl methacrylate, other alkyl acrylates and their derivatives, and other alkyl methacrylates and their derivatives.

14. The method of claim 12 wherein said copolymer is crosslinked with at least one crosslinker.

15. The method of claim 14 wherein said crosslinker is selected from diacrylates and dimethacrylates of bisphenol A ethoxylate (1 EO/phenol), bisphenol A ethoxylate (2 EO/phenol), bisphenol A propoxylate (2 PO/phenol), bisphenol A, 2,2′-diallylbisphenol A, bis(4-(2-acryloylethoxy)phenyl)methane, bis(4-(2-methacryloylethoxy)phenyl)methane, bis(naphthol) A ethoxylate (X EO/naphthol), bis(2-acryloylalkylphenyl)propane, bis(2-methacryloylalkylphenyl)propane, 3,3′-(ethylenedioxy)diphenyl A ethoxylate (X EO/phenol), ethyleneglycol diacrylate, ethyleneglycol dimethacrylate, 1,3-propanediol diacrylate, 1,3-propanediol dimethacrylayte, 1,4-butanediol diacrylate, 1,4-butanediol dimethacrylate, 1,6-hexanediol diacrylate, 1,6-hexanediol dimethacrylate, allyl acrylate, allyl methacrylate, and mixtures thereof, wherein X=1 to 5.

16. The method of claim 12 wherein said copolymer contains a UV absorber.

17. The of method of claim 16 wherein said UV absorber is selected from 2-(4-benzoyl-3-hydroxyphenoxy)ethyl acrylate, 2-hydroxy-4-allyloxybenzophenone, 2-(2′-hydroxy-5-acryloxyethylphenyl)-2H-benzotriazole, and 2-(2′-hydroxy-5-methacryloxyethylphenyl)-2H-benzotriazole, and mixtures thereof.

18. A method for forming a pre-polymer gel for molding of an ophthalmic lens made from a hydrophobic acrylic polymer composition and comprising (a) forming the pre-polymer gel which comprises a hydrophobic acrylic polymer with a number average molecular weight of at least about 1 million; and (b) molding said polymer to form the lens.

19. The method of claim 18 wherein said molecular weight is about 10 million.

20. A method of forming an ophthalmic lens from a hydrophobic acrylic polymer composition by molding said lens or at least its optical portion from said polymer composition in a fused silica mold.

21. The method of claim 20 wherein prior to the molding operation, said fused silica mold is surface treated to form a thin coating on its surface to improve the releasing property of the mold for hydrophobic lenses.

22. The method of claim 21 wherein the surface treatment reagent is trimethylchlorosilane.

23. The method of claim 20 wherein said hydrophobic acrylic polymer composition is a crosslinked homopolymer.

24. The method of claim 23 wherein said homopolymer further contains a UV absorber.

25. The method of claim 20 wherein said hydrophobic acrylic polymer composition is a crosslinked copolymer.

26. The method of claim 25 wherein said copolymer further contains a UV absorber.

27. The method of claim 1 wherein the extraction process is an organic solvent extraction, such that the extracted lens, after being properly dried, remains transparent in an aqueous medium after being soaked in the aqueous medium for at least about 72 hours at about 37° C.

28. The method of claim 27 wherein, after soaking and drying, said ophthalmic lens has a light transmission in the visible wavelength of at least 80% in a aquous medium at 37° C.

29. The method of claim 27 wherein said ophthalmic lens is substantially free of glistenings.

30. The method of claim 27 wherein said extracted lens is subsequently dried at a temperature below the boiling temperature of the organic solvent used for extraction.

31. The method of claim 30 wherein said organic solvent is an alcohol.

32. The method of claim 31 wherein said alcohol is ethyl alcohol.

33. The method of claim 27 wherein said hydrophobic acrylic polymer composition is a crosslinked homopolymer.

34. The method of claim 33 wherein said homopolymer further contains a UV absorber.

35. The method of claim 27 wherein said hydrophobic acrylic polymer composition is a crosslinked copolymer.

36. The method of claim 35 wherein said copolymer further contains a UV absorber.
